(19) United States
(12) Patent Application Publication
(10) Pub. No.: US 2012/0016915 A1
(43) Pub. Date: Jan. 19, 2012

(54) SYSTEM AND METHOD FOR FILE COPY OF CLOUD METHOD AND DISK CLONING OVER WIDE AREA NETWORK

(76) Inventors: Seoung Il CHOI, Gunpo-si (KR); Hyun A. SHIN, Anyang-si (KR); Jong Beom MOON, Seoul (KR)

(21) Appl. No.: 13/183,211

(22) Filed: Jul. 14, 2011

(30) Foreign Application Priority Data
Jul. 15, 2010 (KR) 10-2010-0068637

(51) Int. Cl. G06F 17/30

(52) U.S. Cl. 707/823; 707/E17.01

(57) ABSTRACT

A system and method for cloud scheme-based file copying and disk cloning over a Wide Area Network (WAN) is provided. The system clones a disk of a server to one or more clients. The server includes a cloud cast server module, and an Internet Virtual Partition (IVP) server module. The cloud cast server module receives an image source drive, and designates the received image source drive as a cloud disk. The IVP server module is loaded into RAM, receives a disk management and control right, clones a file system, receives a request for mount, sends the file system and a file. Each of the clients includes a cloud cast client module for receiving the name of a drive and a mount request, requesting the IVP server module to mount the cloud disk, loading the received cloned file system, creating a virtual disk, and creating its own copy file system.

### CROSS REFERENCE

This application claims foreign priority under Paris Convention and 35 U.S.C. §119 to Korean Patent Application No. 10-2010-0068637, filed Jul. 15, 2010 with the Korean Intellectual Property Office.

### BACKGROUND OF THE INVENTION

The present invention relates generally to a system and method for cloud scheme-based file copying and disk cloning over a Wide Area Network (WAN) and, more particularly, to technology on which the next-generation technology will be based and designed in complex ways, and which includes cloud computing and virtualization technology as core technologies. Clouding computing in the present invention is Internet-based service technology in which desired services can be utilized via the Internet even without requiring the expert knowledge of supporting technology. Clouding computing in the present invention is not simply limited to service via the Internet, but includes an LAN/Intranet-based sharing service concept. Clouding computing may be extended to the concept that users can employ computers as the users use their local systems, via other service providers even when they do not have resources necessary for the local systems.

This technology is intended to process distributed resources at a single designated server. A number of users can execute their programs remotely in any places where the users can access the Internet. This technology has been extended from the existing cloud computing concept, has actually been applied, and employs a local execution concept other than simple remote data access or a terminal concept process.

Furthermore, the present invention may provide disk cloning service to a number of computers, located nationwide or worldwide, over a WAN. That is, the present invention has been extended from the LAN/Intranet-based sharing service concept, and implements technology extended to a cloud-based ubiquitous concept anywhere via the Internet by porting the virtual drive technology of a WAN section. The term “WAN” means a network interconnecting wide areas, such as countries and continents. The WAN includes a backbone network interconnecting long-distance areas, and also includes a private network or a leased network as well as a public network. Recently, interest in the global wide area communication network has been rapidly increasing.

The present invention relates to technology in which a number of computers share a single PC, and to a method of sharing the resources of a substantial system other than the existing file sharing method or the existing terminal service concept. According to this technology, a virtual file structure is created in a system for uniquely providing service, and an additional service file is created by compressing and encrypting the virtual file structure. The service file is transferred to a client system over a WAN in the form of a virtual drive, so that it is created in a local system in the form of an additional partition. Accordingly, a client can freely connect to the virtual drive like his or her local PC, freely use programs included in the virtual partition, and perform tasks, such as editing and modification. Here, the results of the editing and modification tasks performed by the client have any no influence on the server. Accordingly, the same data can be provided to a number of computers that require file copying and disk cloning.

The present invention relates to a system and method for cloud scheme-based file copying and disk cloning over a WAN.

The term “cloud computing” means computing technology based on the Internet. Cloud computing may be said to be Web-based software service in which programs placed in a utility data server on the Internet are fetched by a computer or a mobile phone anytime, anywhere and are then used. Attempts at service using the cloud computing technology have recently been made, but they are in the early stages in which the cloud computing concept has not yet been fully established. For this reason, the cloud computing technology does not practically satisfy the needs of users.

Furthermore, an early cloud method recently being attempted heavily relies on the file sharing method. Service using the existing streaming method is problematic in that the number of simultaneous access people is significantly limited because it imposes a heavy load on the system server. Furthermore, service using the existing streaming method is limited to the provision of a cloud scheme-based file sharing service to users who are remotely placed.

### SUMMARY OF THE INVENTION

Accordingly, the present invention has been made keeping in mind the above problems occurring in the prior art, and an object of the present invention is to provide a system and method for cloud scheme-based file copying and disk cloning over a WAN, in which a central server manages various types of data and a number of users located nationwide and worldwide copy files and clone a disk over the WAN, thereby facilitating tasks, such as the patch and update of various types of programs, and being able to extend the disk space of a user's computer without the need to extend actual disk space, and wherein application programs are executed in the central server, thereby being capable of managing a software license very easily.

Another object of the present invention is to provide a system and method for cloud scheme-based file copying and disk cloning over a WAN, in which personal tasks, performed by users located nationwide and worldwide through access to a central server, are applied to only the virtual disks of respective user terminals, thereby being able to provide working environments similar to individual actual local drives. More particularly, a new copy file system, including the file system of the server in the original file system of a client, is created and managed. In the case where a computer user performs a file task or accesses the file of a virtual drive and attempts to perform a task for the file, the user requests the file of an image source drive of the server while referring to the new copy file system, downloads only the file to his or her computer, and performs the task on the file. Accordingly, since a change in the task made by the user does not have any influence on the original file of the server, other users can always use the original file even when a number of users who are placed worldwide perform their tasks using their computers. As a result, the problem in which the existing file sharing method is slow in the information transfer rate and the problem in which data integrity for users is not guaranteed because the contents of all tasks are incorporated into the virtual drive in real time can be solved. Furthermore, the problem of vulnerable security can be solved because a task changed in each client is also incorporated into the server without change and is exposed to other users.

Yet another object of the present invention is to provide a system and method for cloud scheme-based file copying and disk cloning over a WAN, in which files frequently referred to by users and stored in a server, such as music files or moving images, frequently executed application files, or files with large sizes, are downloaded at a time and are then made to reside in the memory of a client or stored in the form of a disk cash created by a local drive. Accordingly, a user can rapidly execute the files using a client computer without the need to access the server and then request data whenever the data is referred to.

In order to achieve the above objects, the present invention provides a system for cloud scheme-based file copying and disk cloning over a Wide Area Network (WAN), the system cloning a disk of a server to one or more clients over the WAN, wherein the server includes a cloud cast server module configured to receive an image source drive from a server administrator, designate the received image source drive as a cloud disk, and generate an interrupt, requesting an Operating system (OS) to hand over a disk management and control right to an Internet Virtual Partition (IVP) server module, and the IVP server module configured to be loaded into RAM by the OS which has received the interrupt, to receive the disk management and control right from the OS, to clone a file system of the server including the cloud disk, to receive a request for mount of the cloud disk from the one or more clients, to send the cloned file system to the clients that have requested the mount over the WAN, to wait for a file provision request from the clients, and to send the file to the clients when the file provision request is received; and each of the one or more clients includes a cloud cast client module for receiving a name of a drive on which the cloud disk of the server will be mounted and a mount request from a user, requesting the IVP server module to mount the cloud disk, receiving the cloned file system of the server over the WAN, loading the received cloned file system into memory, creating a virtual disk by changing a drive name of the cloud disk of the received cloned file system into the name of the drive to be mounted, and creating its own copy file system including the virtual disk in its own original file system.

The cloud cast client module may be configured to further receive information about whether a disk cash will be used and information about a disk cash file path from the user; when the user inputs no use of the disk cash and attempts to access a file included in the virtual disk, request the IVP server module to provide the file, receive the file from the IVP server module, and then execute the file; and when the user inputs use of the disk cash and attempts to access a file included in the virtual disk, search the disk cash file path for the file, if the file is not present in the disk cash file path, request the IVP server module to supply the file, receive the file from the IVP server module over the WAN, store the file in the disk cash, and then execute the file.

The cloud cast client module may further receive information about whether a disk cash will be used and information about a disk cash file path from the user, further receive information about one or more files to be frequently referred to, which belong to files included in the virtual disk, from the user when the user inputs to use the disk cash, request the IVP server module to provide the one or more files, receive the one or more files from the IVP server module over the WAN, store the one or more files in the disk cash, search the disk cash path when the user attempts to the one or more files, and then execute the files.

In order to achieve the above object, the present invention provides a method for cloud scheme-based file copying and disk cloning over a Wide Area Network (WAN), the method including cloning a disk of a server to one or more clients over the WAN, the method including the steps of (a) a cloud cast server module of the server receiving an image source drive from a server administrator and designating the received image source drive as a cloud disk; (b) the cloud cast server module generating an interrupt, requesting an OS to hand over a disk management and control right to an IVP server module of the server; (c) the IVP server module being loaded into RAM by the OS which has received the interrupt generated at step (b); (d) the IVP server module receiving the disk management and control right from the OS and cloning a file system of the server including the cloud disk; and (f) the IVP server module receiving a request for mount of the cloud disk from one or more clients and sending the cloned file system to the clients which have requested to mount the cloud disk over the WAN.

The step (f) may include the steps of (f1) a cloud cast client module of each of the clients receiving a name of a drive on which the cloud disk will be mounted and a mount request from a user; (f2) the cloud cast client module accessing the server using an agent program when the mount request at step (f1) is received; and (f3) the cloud cast client module requesting the IVP server module to mount the cloud disk.

The step (f) may further include the steps of (f4) the cloud cast client module of the client which has requested to mount the cloud disk receiving the cloned file system from the IVP server module over the WAN and loading the received cloned file system into memory; (f5) the cloud cast client module creating a virtual disk by changing a drive name of the cloud disk of the received and cloned file system into the name of the drive to be mounted; (f6) the cloud cast client module creating a copy file system including the virtual disk, created at step f5, in its own original file system; (f7) the cloud cast client module making a determination of whether a file is included in the virtual disk created at step f5 if the user attempts to execute the file; and (f9) if, as a result of the determination at step (f7), the file to be executed by the user is determined not to be included in the virtual disk, the cloud cast client module requesting the file from the IVP server module, receiving the file from the IVP server module, and then executing the file.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a system for cloud scheme-based file copying and disk cloning over a WAN according to a preferred embodiment of the present invention;

FIG. 2 is a diagram schematically showing a process on the server side of a system for cloud scheme-based file copying and disk cloning over a WAN according to a preferred embodiment of the present invention;

FIG. 3 is a diagram schematically showing the process of the transfer of a file system between the server of the system for cloud scheme-based file copying and disk cloning over a WAN and clients according to a preferred embodiment of the present invention;

FIG. 4 is a diagram showing a virtual disk which is created in the client of the system for cloud scheme-based file copying and disk cloning over a WAN according to a preferred embodiment of the present invention;

FIG. 5 is a flowchart illustrating a method for cloud scheme-based file copying and disk cloning over a WAN according to a preferred embodiment of the present invention; and

FIG. 6 is a flowchart illustrating a process on the server side of the method for cloud scheme-based file copying and disk cloning over a WAN according to a preferred embodiment of the present invention.

### DESCRIPTION OF THE PREFERRED EMBODIMENTS

Embodiments of the present invention will be described in detail with reference to the accompanying drawings.

Details of other embodiments are included in the detailed description and the drawings.

Merits and characteristics of the present invention and methods for achieving them will become more apparent from the following embodiments taken in conjunction with the accompanying drawings. However, the present invention is not limited to the disclosed embodiments, but may be implemented in various ways. The embodiments are provided to complete the disclosure of the present invention and to allow those having ordinary skill in the art to fully understand the scope of the present invention. The present invention is defined only by the scope of the claims. The same reference numbers will be used throughout the drawings to refer to the same or like elements.

Hereinafter embodiments of the present invention will be described with reference to the drawings which illustrate a system for cloud scheme-based file copying and disk cloning over a WAN.

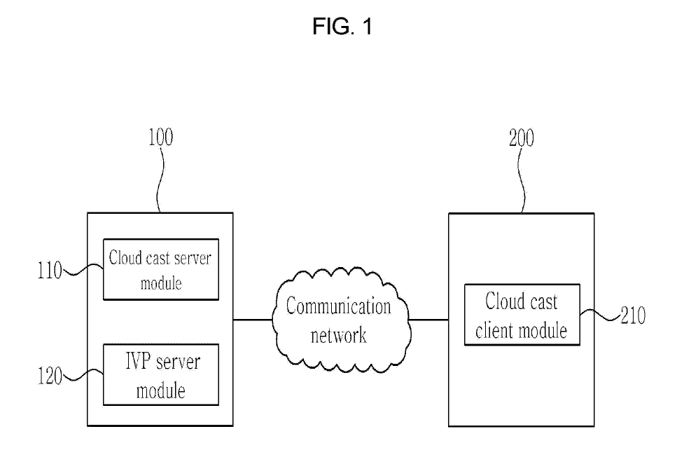

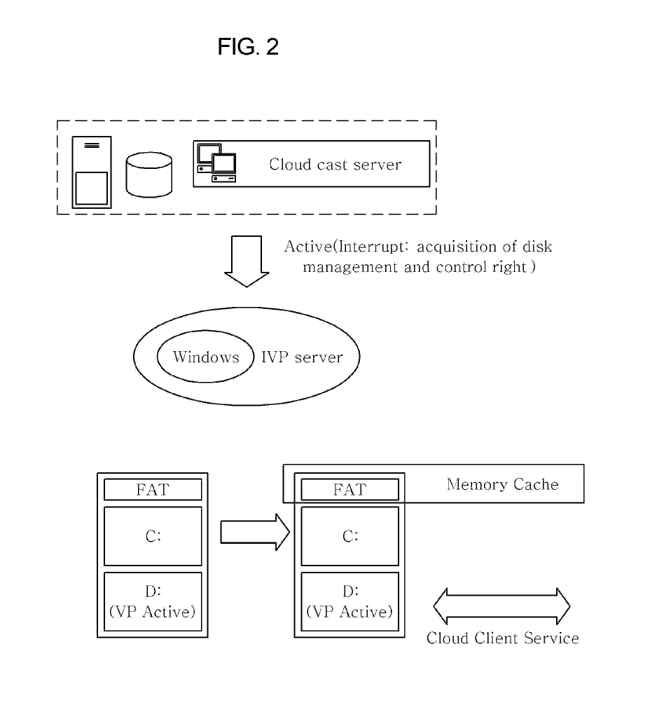

FIG. 1 is a block diagram showing a system for cloud scheme-based file copying and disk cloning over a WAN according to a preferred embodiment of the present invention, and FIG. 2 is a diagram schematically showing a process on the server side of the system for cloud scheme-based file copying and disk cloning over a WAN according to a preferred embodiment of the present invention.

The system for cloud scheme-based file copying and disk cloning over a WAN according to the preferred embodiment of the present invention includes a server 100 and one or more clients 200.

First, the server 100 will now be described with reference to FIG. 1. The server 100 includes a cloud cast server module 110, and an Internet Virtual Partition (IVP) server module 120. The cloud cast server module 110 receives from a server administrator an image source drive which will be designated as a cloud disk to be shared with the clients 200.

Here, the “cloud disk” refers to a disk of a server which will be shared by the plurality of clients 200. A disk input as the image source drive is converted into a disk image using an encrypted imaging scheme, and is then mounted on the clients 200.

The “disk image” refers to a file that stores the contents of a recording medium. The disk image may be decrypted using some compression program as a compressed file is decompressed, and may also be used for emulation using separate virtual CD/DVD software as actual CD/DVD media are used. Using such an image on the drive is called “mount.”

More particularly, it is preferred that the cloud cast server module 110 further receive from the server administrator information about a port and a data transfer packet size to be used for communication with the client 200 over the WAN.

Thereafter, the cloud cast server module 110 generates an interrupt, requesting the IVP server module 120 to hand over a disk management and control right to an Operating System (OS).

Thereafter, the IVP server module 120 receives a request for the mount of a cloud disk from one or more of the clients 200.

Thereafter, the IVP server module 120 clones the file system of the server 100 including the cloud disk, and sends the cloned file system to the requesting, clients 200 over the WAN.

More particularly, the IVP server module 120 is loaded into RAM by the OS which has received an interrupt request from the cloud cast server module 110.

While being loaded into the RAM, the IVP server module 120 receives the disk management and control right from the OS, and clones the file system of the server 100 including the cloud disk.

Thereafter, the IVP server module 120 loads the cloned file system into shadow memory.

Thereafter, the IVP server module 120 checks whether the file system of the server 100 is being changed by the OS in real time. If there is a change in the file system, the IVP server module 120 incorporates the changed contents of the file system into the cloned file system.

Thereafter, the IVP server module 120 receives a request for the mount of the cloud disk from one or more of the clients 200, and sends the cloned file system to the requesting clients 200 over the WAN.

Here, it is preferred that the IVP server module 120 of the server 100 create the cloned file system using an image encryption technique.

That is, the term “image encryption technique” refers to a technique that does not create a virtual drive in simple file sharing form, but creates a disk drive in a compressed file form from the point of view of the server, in order to solve a security problem that may occur when a file of the server is shared by client systems.

This method is very different from a file sharing concept provided by Windows, and may function to prevent access through an unauthorized user because one image file actually encrypted operates as a local disk on the client side.

A preferred embodiment of the process on the server side according to the present invention will now be described in detail with reference to FIG. 2. An original image source drive designated as a cloud disk and to be shared by the clients, a TCP port number to be used for communication with the client, and a data transfer packet size for the client are received, and an active button is then pressed. From FIG. 2, it can be seen that D: drive is designated as the cloud disk.

In response thereto, the cloud cast server module 110 outputs an interrupt to the Windows OS so that the IVP server module 120 is loaded into the RAM and then hands over a disk management and control right to the IVP server module 120.

When being loaded into the RAM by the Windows OS, the IVP server module 120 clones the file system of the server including the drive designated as the cloud disk, and loads the cloned file system into the shadow memory. The reason for this is to rapidly respond to a request for the mount of the cloud disk from the clients 200.

FIG. 2 shows that the IVP server module 120 creates a File Allocation Table (FAT) by cloning a FAT (i.e., the original file system of the server 100) and loads the created FAT into the memory.

Furthermore, the IVP server module 120 monitors the disk management of the OS in real time. If the original file system FAT changes, the IVP server module 120 immediately incorporates changed contents into a copy file system FAT′ so that a rapid response to a request from the clients 200 can be made based on the changed information of the server.

That is, the IVP server module 120 resides in the memory and, if there is a request from the client 200, sends the cloned copy file system FAT′ to the client 200.

The reason why the IVP server module 120 is illustrated as including Windows in FIG. 2 is that the IVP server module 120 has priority in disk management.

Furthermore, the cloud cast server module 110 may receive a request for the release of the mount on the client 200 or a request for remount from the server administrator.

When the mount release request is received from the server administrator, the client server module 110 releases the mount on the client 200 on which the cloud disk has been mounted. It is very much preferred that when the remount request is received, the client server module 110 temporarily releases the mount, and performs remount on the clients 200 that have requested the mount of the cloud disk.

By doing so, the central server can easily perform data management, software license management, and system management, such as a response to the generation of a load in the server. Accordingly, satisfactory file sharing and disk cloning services can be provided to users.

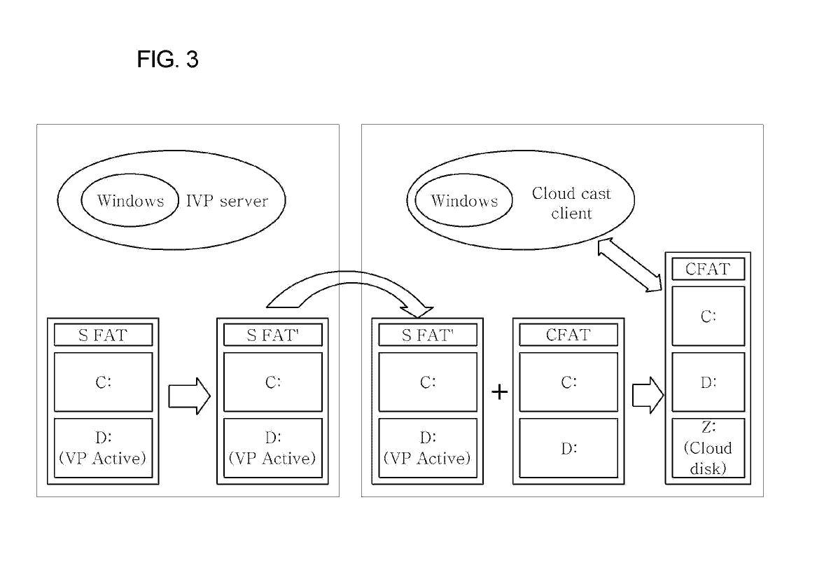

FIG. 3 is a diagram schematically showing the process of the transfer of a file system between the server of the system for cloud scheme-based file copying and disk cloning over a WAN and the clients according to a preferred embodiment of the present invention.

The one or more clients 200 will now be described below with reference to FIGS. 1 and 3. Each of the clients 200 includes a cloud cast client module 210.

The cloud cast client module 210 receives the name of a drive on which a cloud disk will be mounted, and a mount request from a user.

Thereafter, the cloud cast client module 210 accesses the server 100 through an agent program, and requests the IVP server module 120 to mount a cloud disk.

That is, the agent program accesses the server 100 using the designated IP of the server 100, and requests the IVP server module 120 to mount the cloud disk using a TCP communication port, the information of which was received by the cloud cast server module 110.

Furthermore, it would be preferred that the cloud cast client module 210 copies the original file system CFAT of a corresponding client 200 and loads it into the memory.

Thereafter, the cloud cast client module 210 receives a cloned file system SFAT′ from the IVP server module 120 over the WAN, loads the cloned file system SFAT′ into the memory, and creates a virtual disk by changing the drive name of a cloud disk of the received cloned file system SFAT′ into the name of a drive to be mounted.

Here, the term “virtual disk” refers to a virtual partitioned space. The virtual disk created in the client according to the present invention does not simply play the role of a network drive, but operates as the hard disk of a local system. The virtual disk is a disk encrypted and imaged in the server, and operates as one image file other than an actual partition.

Furthermore, the cloud cast client module 210 creates the copy file system CFAT′ of the corresponding client, including the virtual disk, in the original file system of the corresponding client.

That is, referring to FIG. 3, a D: drive which has been designated as a cloud disk in the server 100 is changed into the Z: drive of the client 200 which has been designated as a drive to be mounted, thus creating the virtual disk. The Z: drive (i.e., the virtual disk) is included in the original file system CFAT, thus creating the new copy file system CFAT′ of the client 200.

Accordingly, it can be seen that the Z: drive of the client 200 is created by changing the D: drive (i.e., the cloud disk of the server 100) and is a virtual disk on which the cloud disk of the server 100 is mounted and shared.

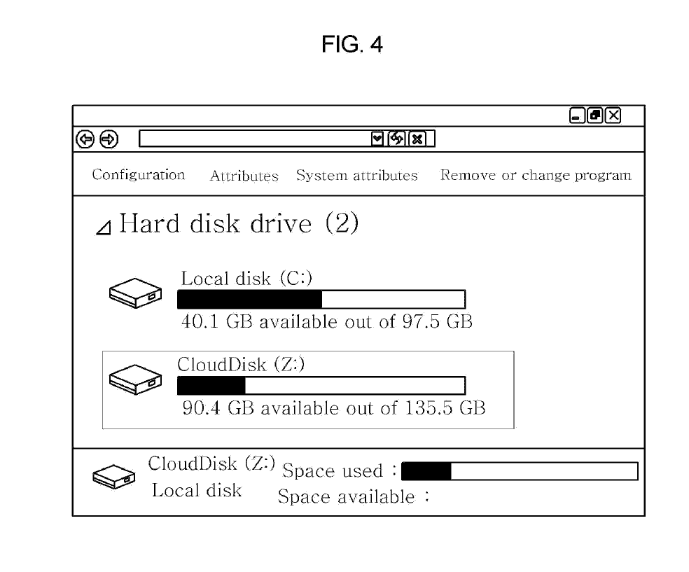

FIG. 4 is a diagram showing a virtual disk which is created in the client of the system for cloud scheme-based file copying and disk cloning over a WAN according to a preferred embodiment of the present invention.

From FIG. 4, it can be seen that when the client 200 actually having a C: drive executes the cloud cast client module 210 and maps the cloud disk D: drive of the server 100 to the virtual disk Z: drive so that the virtual disk Z: drive is automatically shared, the virtual disk Z: drive resembles an actual local drive.

Meanwhile, when the original file system is changed by a user, the cloud cast client module 210 incorporates the changed contents into the copy file system.

Furthermore, it is preferred that when a user accesses a file included in the virtual disk, the cloud cast client module 210 request the IVP server module 120 to provide the file, receive the file from the IVP server module 120 over a WAN, and execute the file.

That is, the cloud cast client module 210 of the client 200 will now be described in greater detail with reference to FIGS. 3 and 4. The cloud cast client module 210 receives the name of a drive on which a cloud disk will be mounted, information about whether a disk cash will be used, a disk cash file path, information about whether automatic mount will be performed when a computer is booted, and a mount request from a user.

Thereafter, when the user inputs the use of a disk cash and attempts to access a file included in a virtual disk on which the cloud disk has been mounted, the cloud cast client module 210 checks whether the file is present in the disk cash file path.

If the file is not present in the disk cash file path, it is preferred that the cloud cast client module 210 request the IVP server module 120 to provide the file, receive the file from the IVP server module 120 over a WAN, store the file in the disk cash, and execute the file.

It is preferred that when the user inputs no use of the disk cash and attempts to access a file included in the virtual disk, the cloud cast client module 210 request the IVP server module 120 to provide the file, receive the file from the IVP server module over a WAN, and execute the file.

Furthermore, it is preferred that when the user inputs the use of the disk cash, the cloud cast client module 210 further receive information about one or more files to be frequently referred to, which belong to the files included in the virtual disk created by mounting the cloud disk, from the user.

Furthermore, it is preferred that the cloud cast client module 210 request the IVP server module 120 of the server 100 to provide the one or more files to be frequently referred to, receive the files from the IVP server module 120 over the WAN, and store the files in the disk cash.

Furthermore, it is preferred that when the user accesses the one or more files to be frequently referred to and attempts to perform a task on them, the cloud cast client module 210 directly search the disk cash path for the files and then execute the files without the need to access the server 100 and to request the files from the IVP server module 120.

By doing so, files frequently referred to by a user and stored in the cloud disk of the server 100, such as music files or moving images, frequently executed application files, or files having a very high capacity, are made to reside in the memory of the client or are stored in a disk cash created through the local drive of the client 200. Accordingly, a user can rapidly execute corresponding data using the computer of the client 200 without calling the server 100 and requesting the corresponding data from the server 100 whenever the user needs the data.

Furthermore, if the computer of the client 200 is set such that the sharing disk of the cloud server 100 is automatically mounted when it is booted, a user can use the recently updated sharing disk of the cloud server 100 without requiring additional environment settings.

Furthermore, when a mount request is received from a user, the cloud cast client module 210 receives the cloned file system of the server 100 from the IVP server module 120 of the server 100, and newly creates the copy file system CFAT′ of the client 200.

Furthermore, the cloud cast client module 210 checks whether the original file system CFAT has been changed. If there is a change in the original file system CFAT, the cloud cast client module 210 incorporates the change into the copy file system CFAT′ in real time. That is, if the user performs a task on a file included in the original file system, other than a file included in a virtual disk Z: drive on which the cloud disk has been mounted, all task results, such as data modification, data deletion, and data addition, are incorporated into the original file system CFAT. In this case, the cloud cast client module 210 also incorporates the changed contents of the original file system CFAT into the copy file system CFAT′.

In contrast, if the user accesses the file included in the virtual disk Z: drive and attempts to perform a task on the file, the cloud cast client module 210 requests the file from the IVP server module 120 of the server 100 while referring to the copy file system CFAT′, and the IVP server module 120 sends the file to the client 200 over a WAN while referring to the cloned file system SFAT′ of the server 100.

That is, the entire program to be actually executed is not fetched, but only modules necessary for execution are requested. The client 200 does not call all associated data. However, data to which is frequently referred is made to reside in the memory of the client 200 or is stored in a disk cash created through the local drive of the client 200.

In this case, if the local drive of the client 200 changes, the copy file system CFAT′ changes, but the file system of the server 100 is not influenced at all.

Accordingly, the client 200 includes two file systems so that the original file system CFAT of the client 200 is responsible for changes in data on the client (200) side and the copy file system CFAT′ is responsible for disk management only when the cloud disk of the server 100 remains accessed. Accordingly, the client 200 can restore a change in a file and data, included in the cloud disk, to its original state when the client 200 is rebooted.

By doing so, in the case where data is transmitted to the plurality of clients 200 by sharing of the cloud disk, a change influences only the client of the user but does not influence the file system of the server 100, even when a user who has first received the data changes the data. Accordingly, the server 100 can provide the same data to other users.

Accordingly, a plurality of clients can copy the files of the server 100 using a cloud scheme or refer to various media files or games with a very large size, corresponding to that of one or two sheets of DVD, by means of disk cloning. Furthermore, the files or the various media files or games can be executed by computers, placed worldwide or nationwide, at the same time over a WAN. Furthermore, the files or the various media files or games can be modified and edited by each client as in the local disk of the client. Accordingly, the present invention may be very useful in the offices of medium and small-sized businesses, Internet game rooms, and the laboratories of various education institutes.

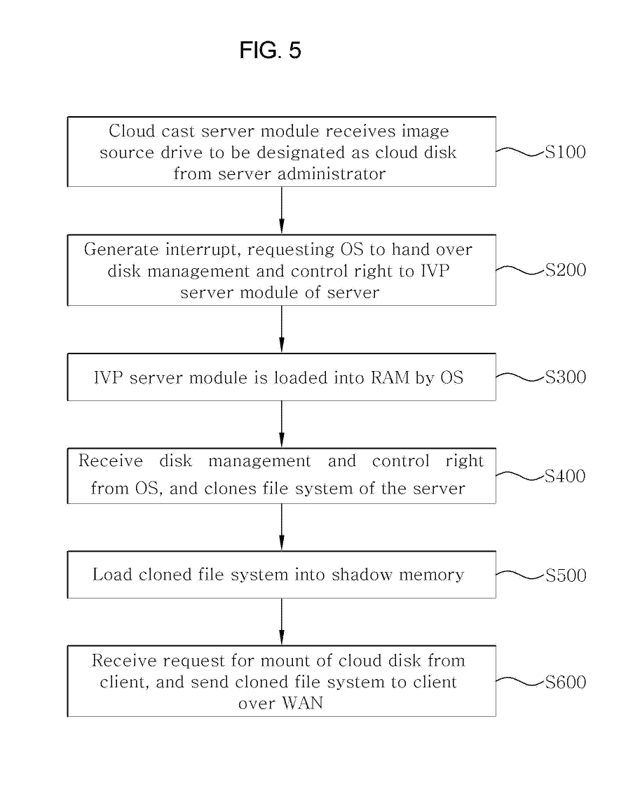

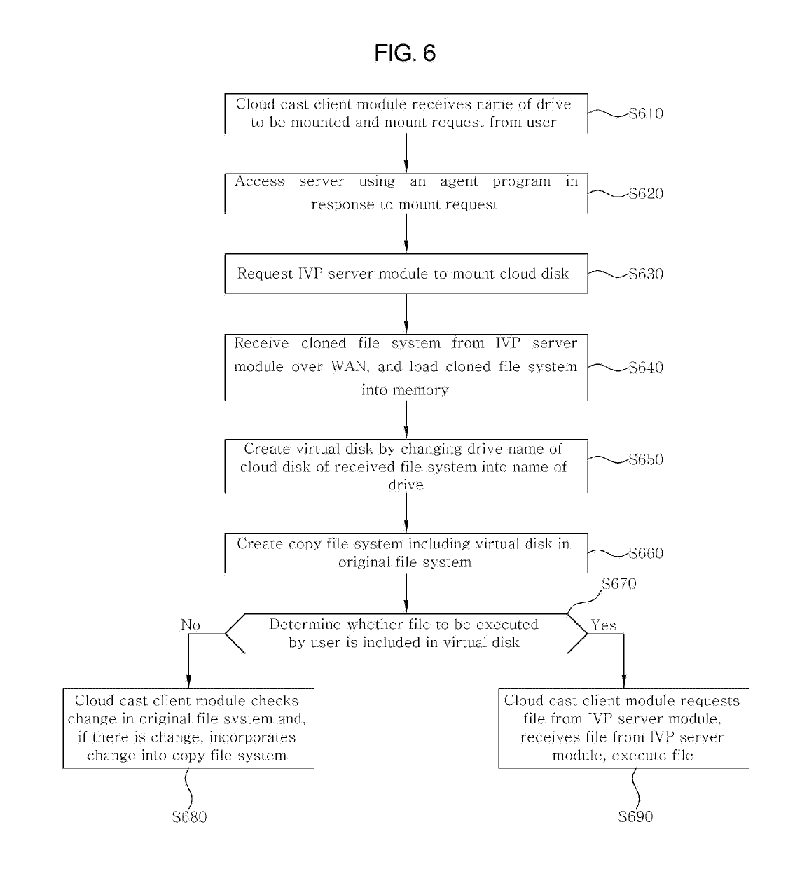

FIG. 5 is a flowchart illustrating a method for cloud scheme-based file copying and disk cloning over a WAN according to a preferred embodiment of the present invention, and FIG. 6 is a flowchart illustrating a process on the server side of the method for cloud scheme-based file copying and disk cloning over a WAN according to a preferred embodiment of the present invention.

The method for cloud scheme-based file copying and disk cloning over a WAN according to the preferred embodiment will now be described below with reference to FIGS. 5 and 6.

First, the cloud cast server module 110 of the server 100 receives an image source drive which will be designated as a cloud disk to be shared with the clients 200 from a server administrator at step S100.

Here, it would be preferred that the cloud cast server module 110 further receive information about a port and a data transfer packet size to be used for communication with the client from the server administrator over the WAN.

Thereafter, the cloud cast server module 110 generates an interrupt requesting an OS to hand over a disk management and control right to the IVP server module 120 of the server 100 at step S200.

Thereafter, the IVP server module 120 is loaded into the RAM by the OS which has received the interrupt request at step S300.

Thereafter, the IVP server module 120 receives the disk management and control right from the OS, and clones the file system of the server 100 including a cloud disk at step S400.

Thereafter, the IVP server module 120 loads the cloned file system into the shadow memory at step S500.

Finally, the IVP server module 120 receives a request for the mount of the cloud disk from the one or more clients 200, and sends the cloned file system to the clients 200 which have requested the mount of the cloud disk over the WAN at step S600.

The preferred embodiment of the cloud cast client module 210 of the clients 200 will now be described below with reference to FIG. 6.

First, the cloud cast client module 210 of the client 200 receives the name of a drive to be mounted and a mount request from a user at step S610.

In response to the mount request, the cloud cast client module 210 accesses the server 100 using an agent program at step S620.

Thereafter, the cloud cast client module 210 requests the IVP server module 120 to mount a cloud disk at step S630.

In response to the request, the IVP server module 120 sends a cloned file system of the server 100 to the client 200 over the WAN.

The cloud cast client module 210 of the clients 200 which has requested the mount of the cloud disk receives the cloned file system from the IVP server module 120 over the WAN and loads the cloned file system into the memory at step S640.

The cloud cast client module 210 creates a virtual disk by changing the drive name of a cloud disk of the received cloned file system into the name of the drive at step S650.

The cloud cast client module 210 creates a copy file system, including the virtual disk created at step S650 in the original file system of the client 200 at step S660.

If a user attempts to execute a file, the cloud cast client module 210 determines whether the file is included in the virtual disk, created at step S650, at step S670.

If, as a result of the determination at step S670, the file is determined not to be included in the virtual disk, the cloud cast client module 210 checks whether there is a change in the original file system, and, if there is a change, incorporates the change into the copy file system at step S680.

However, if, as a result of the determination at step S670, the file is determined to be included in the virtual disk, the cloud cast client module 210 requests the file from the IVP server module 120, receives the file from the IVP server module 120 and executes the file at step S690.

As described above, according to the present invention, there is provided a system and method for cloud scheme-based file copying and disk cloning over a WAN, in which a central server manages various types of data and a number of users located nationwide and worldwide copy files and clone a disk over the WAN, thereby facilitating tasks, such as the patch and update of various types of programs, and being able to extend the disk space of a user's computer without the need to extend actual disk space, and wherein application programs are executed in the central server, thereby being capable of managing a software license very easily.

Furthermore, according to the present invention, there is provided a system and method for cloud scheme-based file copying and disk cloning over a WAN, in which personal tasks, performed by users located nationwide and worldwide through access to a central server, are applied to only the virtual disks of respective user terminals, thereby being able to provide working environments similar to individual actual local drives. More particularly, a new copy file system, including the file system of the server in the original file system of a client, is created and managed. In the case where a computer user performs a file task or accesses the file of a virtual drive and attempts to perform a task for the file, the user requests the file of an image source drive of the server while referring to the new copy file system, downloads only the file to his or her computer, and performs the task on the file. Accordingly, since a change in the task made by the user does not have any influence on the original file of the server, other users can always use the original file even when a number of users who are placed worldwide perform their tasks using their computers. As a result, the problem in which the existing file sharing method is slow in the information transfer rate and the problem in which data integrity for users is not guaranteed because the contents of all tasks are incorporated into the virtual drive in real time can be solved. Furthermore, the problem of vulnerable security can be solved because a task changed in each client is also incorporated into the server without change and is exposed to other users.

Furthermore, according to the present invention, there is provided a system and method for cloud scheme-based file copying and disk cloning over a WAN, in which files frequently referred to by users and stored in a server, such as music files or moving images, frequently executed application files, or files with large sizes, are downloaded at a time and are then made to reside in the memory of a client or stored in the form of a disk cash created by a local drive. Accordingly, a user can rapidly execute the files using a client computer without the need to access the server and then request data whenever the data is referred to.

It will be understood by those having ordinary skill in the art to which the present invention pertains that the present invention may be implemented in various specific forms without changing the technical spirit or indispensable characteristics of the present invention. Accordingly, it should be understood that the above-described embodiments are illustrative and not limitative from all aspects. The scope of the present invention is defined by the appended claims rather than the detailed description, and the present invention should be construed to cover all modifications or variations induced from the meaning and scope of the appended claims and their equivalents.

What is claimed is:

1. A system for cloud scheme-based file copying and disk cloning over a Wide Area Network (WAN), the system cloning a disk of a server to one or more clients over the WAN, wherein:
the server comprises:
a cloud cast server module configured to receive an image source drive from a server administrator, designate the received image source drive as a cloud disk, and generate an interrupt, requesting an Operating system (OS) to hand over a disk management and control right to an Internet Virtual Partition (IVP) server module, and
the IVP server module configured to be loaded into RAM by the OS which has received the interrupt, to receive the disk management and control right from the OS, to clone a file system of the server including the cloud disk, to receive a request for mount of the cloud disk from the one or more clients, to send the cloned file system to the clients that have requested the mount over the WAN, to wait for a file provision request from the clients, and to send the file to the clients when the file provision request is received; and
each of the one or more clients comprises a cloud cast client module for receiving a name of a drive on which the cloud disk of the server will be mounted and a mount request from a user, requesting the IVP server module to mount the cloud disk, receiving the cloned file system of the server over the WAN, loading the received cloned file system into memory, creating a virtual disk by changing a drive name of the cloud disk of the received cloned file system into the name of the drive to be mounted, and creating its own copy file system including the virtual disk in its own original file system.

2. The system as set forth in claim 1, wherein the cloud cast client module is configured to:
further receive information about whether a disk cash will be used and information about a disk cash file path from the user;
when the user inputs no use of the disk cash and attempts to access a file included in the virtual disk, request the IVP server module to provide the file, receive the file from the IVP server module, and then execute the file; and
when the user inputs use of the disk cash and attempts to access a file included in the virtual disk, search the disk cash file path for the file, if the file is not present in the disk cash file path, request the IVP server module to supply the file, receive the file from the IVP server module over the WAN, store the file in the disk cash, and then execute the file.

3. The system as set forth in claim 1, wherein the cloud cast client module further receives information about whether a disk cash will be used and information about a disk cash file path from the user, further receives information about one or more files to be frequently referred to, which belong to files included in the virtual disk, from the user when the user inputs to use the disk cash, requests the IVP server module to provide the one or more files, receives the one or more files from the IVP server module over the WAN, stores the one or more files in the disk cash, searches the disk cash path when the user attempts to the one or more files, and then executes the files.

4. A method for cloud scheme-based file copying and disk cloning over a Wide Area Network (WAN), the method including cloning a disk of a server to one or more clients over the WAN, the method comprising the steps of:
(a) a cloud cast server module of the server receiving an image source drive from a server administrator and designating the received image source drive as a cloud disk;
(b) the cloud cast server module generating an interrupt, requesting an OS to hand over a disk management and control right to an IVP server module of the server;
(c) the IVP server module being loaded into RAM by the OS which has received the interrupt generated at step (b);
(d) the IVP server module receiving the disk management and control right from the OS and cloning a file system of the server including the cloud disk; and
(f) the IVP server module receiving a request for mount of the cloud disk from one or more clients and sending the cloned file system to the clients which have requested to mount the cloud disk over the WAN.

5. The method as set forth in claim 4, wherein the step (f) comprises the steps of:
(f1) a cloud cast client module of each of the clients receiving a name of a drive on which the cloud disk will be mounted and a mount request from a user;
(f2) the cloud cast client module accessing the server using an agent program when the mount request at step (f1) is received; and
(f3) the cloud cast client module requesting the IVP server module to mount the cloud disk.

6. The method as set forth in claim 5, wherein the step (f) further comprises the steps of:
(f4) the cloud cast client module of the client which has requested to mount the cloud disk receiving the cloned file system from the IVP server module over the WAN and loading the received cloned file system into memory;
(f5) the cloud cast client module creating a virtual disk by changing a drive name of the cloud disk of the received and cloned file system into the name of the drive to be mounted;
(f6) the cloud cast client module creating a copy file system including the virtual disk, created at step f5, in its own original file system;
(f7) the cloud cast client module making a determination of whether a file is included in the virtual disk created at step f5 if the user attempts to execute the file; and
(f9) if, as a result of the determination at step (f7), the file to be executed by the user is determined not to be included in the virtual disk, the cloud cast client module requesting the file from the IVP server module, receiving the file from the IVP server module, and then executing the file.
